(19) United States
(12) Patent Application Publication
(10) Pub. No.: US 2017/0078391 A1
(43) Pub. Date: Mar. 16, 2017

(54) SYSTEM AND METHOD FOR THE ANALYSIS OF AN OBJECT

(71) Applicant: SIEMENS AKTIENGESELLSCHAFT, München (DE)

(72) Inventor: AMIT VERMA, Erlangen (DE)

(73) Assignee: SIEMENS AKTIENGESELLSCHAFT, München (DE)

(21) Appl. No.: 15/265,281

(22) Filed: Sep. 14, 2016

(30) Foreign Application Priority Data
Sep. 15, 2015 (EP) 15185275.3

(51) Int. Cl. H04L 29/08; H04L 12/14

(52) U.S. Cl. CPC H04L 67/1097; H04L 12/1432; H04L 67/02

(57) ABSTRACT

A system for the analysis of an object includes a first computer unit locally associated with the object and including a first data store having data of the object, and a first application for processing data of the first data store for transfer to the first data store for communication to the object. A second computer unit is provided and includes a second data store and a second application for processing data of the second data store for transfer to the second data store. An agent associated with the first computer unit provides data of the first data store via the Internet to the second data store and/or receives data from the second data store. A blocking module associated with the first computer unit blocks a data exchange between the first data store and the second data store in direction from the second data store to the first data store.

### CROSS-REFERENCES TO RELATED APPLICATIONS

This application claims the priority of European Patent Application, Serial No. 15185275.3, filed Sep. 15, 2015, pursuant to 35 U.S.C. 119(a)-(d), the disclosure of which is incorporated herein by reference in its entirety as if fully set forth herein.

### BACKGROUND OF THE INVENTION

The present invention relates to a system and a method for the analysis of objects of a system operator by means of passive data collectors and a blocking module for suppressing commands to the objects.

The following discussion of related art is provided to assist the reader in understanding the advantages of the invention, and is not to be construed as an admission that this related art is prior art to this invention.

The present invention belongs to the field of the safety of agent-based data collections for “cloud-based” systems and service. The invention also relates to the field of the “Internet of Things” (IoT) and the “Web of Systems” (WoS). In agent-based data collections, these agents represent the interface between the data source and the cloud-based system. They collect the data and transmit the data to the system. The transmission of the data can take place directly, via intermediaries (known as “proxies”) or via gateways. The data source is automation units or research units in an industrial automation system. These can be programmable control systems, field devices with controllers such as motors, inverters, sensors, but also controllers in automobiles, light signal systems, cameras or the like. The agents can be pure software agents which in this case are integrated directly into the aforementioned control systems or controllers and function there as data collectors. Alternatively, the agent can also run on dedicated hardware which connects the data source indirectly via communications protocols (Siemens S7, Profibus, Modbus, OPC DA/UA, SOAP/XML, etc.). With regard to the requirements for the coupling of the data source via agents, these can be subdivided into the following types.

In one case, the agent should collect data from the data source, send it to the cloud-based system and/or be able to receive control signals from the cloud-based system to the data source. An example of a data collection and control agent of this type could be an agent in a motor which, in a simple case reads data, for example, acceleration data from sensors in the motor and transmits this data for analytical purposes to the cloud-based system. If what is involved is a motor which is exposed for the industrial automation system due to its function and must therefore be monitored, the cloud-based system could identify an anomaly after evaluation of the data and transmit a stop command to the agent which then in turn transmits a corresponding signal for the stopping of the motor to the control system of the motor.

In another case, the agent is a passive data collector which merely collects data and transmits it to the cloud-based system which carries out further analytical functions with this data. This form of agent should not receive any commands from the cloud-based system.

The introduction of such data-collecting agents which connect to cloud-based systems have various safety-relevant consequences in the industrial environment. The agents expose the industrial automation system and the individual automation and computer system to the internet. Even an agent directly or indirectly connected to a control system in a car which is connected to the internet can give cause for concern. Thus, cloud-based systems which are connected via the internet and agents to the control systems are perceived by the customers to be threatening. For this reason and in order to minimize the safety risks, predominantly agents which are only passive data collectors and only permit a connection to the cloud (outbound) are allowed. But such passive agents are also not always regarded as safe by customers. It is thus feared that passive agents can be penetrated from outside and can be so changed that they nevertheless transmit control commands to the automation or computer unit. The risk also exists that a passive agent transmits control signals to the data source due to configuration or implementation errors of the agent. It is attempted to counter this in that the passive agents are configurable such that they function exclusively in an outbound connection mode. However, in this mode also, it is possible in some circumstances to transmit control commands to the automation or computer unit, specifically via the response communication to an outbound request. If an infection of passive agents with harmful software succeeds, this could be instigated by transmitting modified signals or commands to the automation and computer units. Depending on the actual usage case, it could occur that an agent of this type is to be activated later, for example, for remote services from the cloud which then - at least for a certain time - would mean the control of the automation or computer unit.

It would therefore be desirable and advantageous to provide an improved system and method which obviate prior art shortcomings and which increase safety and prevent a passive agent from transmitting control signals to an automation unit.

### SUMMARY OF THE INVENTION

According to one aspect of the present invention, a system for the analysis of an object of a system operator includes a first computer unit which is locally associated with the object, the first computer unit including a first data store which includes data of the object, a first evaluation unit, and a first application which causes the first evaluation unit to process data of the first data store so as to produce a first result for transfer to the first data store for communication to the object, a second computer unit which includes a second data store, a second evaluation unit, and a second application which causes the second evaluation unit to process data of the second data store so as to produce a second result for transfer to the second data store, an agent associated with the first computer unit and providing data of the first data store via the Internet to the second data store and/or receiving data from the second data store, and a blocking module associated with the first computer unit and configured to block a data exchange between the first data store and the second data store in a direction from the second data store to the first data store.

In the system for analyzing at least one object, it is the object of a system operator that is involved here. An object in this context relates, for example, to an automation system in factory automation, which includes a series of different automation components essentially in the control and field domain, for example, programmable control systems. The term “object” relates to any intelligent and software-equipped field or control component, including a drive, monitoring or sensor component, for example, motor or inverter. The objects are typically networked among one another and are operated and/or monitored by different, hierarchically arranged, higher-order control systems. Aside from the above-described objects within a factory automation system, the term “object” also relates to any object which—regardless of its operating environment—executes control and monitoring functions connected to a computer unit. For example, vehicles (road vehicles, agricultural vehicles and rail vehicles) can represent such an object, but also intelligent devices in the field of domestic control and monitoring. System operators should be understood as being those in whose ownership or possession the object is or in whose direct sphere of influence and with whose data the object operates.

At least one first computer unit is locally associated with the object. Typically, the computer unit is situated in structural unity with the object. However, it is also conceivable that the object and its computer unit do not form a structural unity. However, even in such a case, the computer unit and the object should be situated in spatial proximity to one another, but at least be situated within the limits of the sphere of influence of the system operator within a local communication network. The first computer unit has data stores, at least one evaluation unit and at least one application. The evaluation unit is realized as a combination of hardware and software. It is configured as a stand-alone computer unit separate from the data stores, but can also include them. The data stores include data of the object. In this respect, data stores should also be understood as internal registers or data variables. The data of the objects can be internal object data or data of the object periphery (from sensors or actuators for the object). The application causes the evaluation unit to process data of the first data store and to transfer the results therefrom to the data store for communication—in particular as control signals—to the object or to a higher-order control system.

The system includes an agent and a second computer unit. The second computer unit is situated remote from the first computer unit and in the ownership, possession or sphere of influence of a service operator. What is involved here is a cloud-based computer unit. The second computer unit includes second data stores, a second evaluation unit and at least one second application. The agent is associated with the first computer unit. This should be understood to mean that the agent is either installed as a pure software agent directly on the hardware of the first computer unit and therefore also uses the evaluation unit of this computer unit, or that the agent is implemented as software on dedicated hardware and maintains a dedicated communication connection within the local communication network to the computer unit of the object. The agent transfers data from first data stores, via the Internet, to second data stores. Herein, the agent can access the first data store for reading. Alternatively, the agent can also collect data before it is stored in first data stores. The second application causes the second evaluation unit to process data of the second data stores and to transfer the results therefrom to the second data stores. In this form, the second evaluation unit is also configured as a separate computer unit separate from the second data stores.

In order to prevent control commands for the object from the second computer unit to the first computer unit undesirably carrying out actions of the object or manipulating data in the first data stores, a blocking module (“CIL”—Control Inhibition Layer) is implemented which blocks the transfer of data between the first and second data stores in the direction from the second data store to the first data store. The blocking module only permits read accesses of the agent to the first data store. It suppresses all modify/write/control commands of the agent to the first data stores or to the evaluation unit of the first computer unit of the object. From the standpoint of functional organization, the blocking module or the blocking layer is situated between the first computer unit and the agent. The blocking module assumes the role of an onlooker, similarly to an antivirus program or a firewall, and thereby monitors a communication of the agent with the first data stores of the computer unit in that it places itself as a blocking layer between the communication. When the communication takes place at all times between the agent and the first data stores, the blocking module makes the decision to permit or to block this communication. If a write attempt into a first data store is made by the agent, it is blocked.

According to another advantageous feature of the present invention, the data exchange between the first data store and the second data store can be blocked in a direction from the first data store to the second data store. This can be advantageous substantially when it is desired by the system operator to reliably prevent data traffic into the cloud-based computer unit entirely or for a particular time. In this case, read attempts by the agent from the first data stores are suppressed.

According to another advantageous feature of the present invention, the blocking module can only be accessed by a rule editor that is configurable by the system operator. The system operator is capable of defining rules which can make stipulations as far as the data level. For example, for particular categories of data which have no accesses to the objects and thus are not relevant for the process control, write accesses can be permitted. According to a more complex embodiment, the blocking module can receive configuration rules which stipulate, for example, which category of control commands are to be blocked. Thus, for example, target temperature specifications for a blast furnace are blocked, whereas target temperature specifications for a heat-treatment process in a range of plus/minus 5 degrees can be permitted. According to another configuration rule, for example, it could be specified which category of data can be read passively from the data source and which not. Thus it is conceivable that the system operator specifies via the rule editor that the agent may not read any KPIs (key performance indicators) with regard to the production, since these represent sensitive data for the system operator, which he does not wish to have stored in a computer unit external to the plant.

In order to increase transparency and for reporting purposes, in a further variant, the blocking module can also maintain statistics about how many communication requests have been handled, blocked or approved.

According to another advantageous feature of the present invention, the blocking module can be implemented as a separate software module in an independent blocking program (e.g., cil.exe) of the first computer unit. In this way, it uses the evaluation unit (CPU) of the first computer unit, and, for example, also the application for the agent (e.g. agent.exe). Whereas the agent normally uses more complex and/or more numerous communication libraries or software modules of third party providers (OpenSSL) and is therefore subject to a greater risk of being attackable, the blocking module—compared with the agent—has only a very specific and relatively simple function. It is designed and programmed with a higher safety standard, for example, stricter storage protection mechanisms, stricter error monitoring, etc. and/or uses only a small number of libraries, which significantly reduces the potential attack area. The typically occurring conflict between, firstly, safety and, secondly, efficiency and usability can be taken into account in this way. Via the blocking module, a higher safety standard can be implemented, which is not possible in a practical context with the agent (due to necessary efficiency and binding-in of Open Source Software).

According to another advantageous feature of the present invention, the blocking module can be implemented in the form of a service process and can be called by the agent using a communication request. Once the agent has formulated a communication request for the data store, the blocking module initially obtains this communication request from the agent linked to the requirements for the release of this communication. When the blocking module does not grant this approval, the agent discards the communication request again, but in the case of active release, the agent can open the communication. In this variant, the blocking module supplies only the decision and the communication itself remains the responsibility of the agent.

According to another advantageous feature of the present invention, the first computer unit can include a third administration application that administers the first data store, with the blocking module being callable from the third administration application after the making of the communication request by the agent. When the blocking module does not grant this release, the third administration application discards the communication request again, but in the case of active approval, access to the data source is permitted by the blocking module. As in the previous variant, here again the blocking module supplies only the decision and the communication itself remains the responsibility of the agent and the data source.

According to another advantageous feature of the present invention, the blocking module can be implemented on dedicated hardware. This is advantageous, in particular, when the agent is also implemented in dedicated hardware. In this variant, the blocking module is bound into the plant-side communication network and reads the communication on the network. For all TCP/IP-based communication protocols (e.g. Profinet, Modbus, TCP/IP), the blocking module can block the communication to the data stores. In this way, the approval or blocking decisions described above can advantageously be carried out by a single blocking module, including for a plurality of first computer units.

According to another advantageous feature of the present invention, the blocking module can include a mediator module to inject mediator functions into runtime library of communication protocols, which notify the blocking module regarding communication requests. The mediator module is a software procedure which accesses the libraries via the existing library interfaces and amends the code of the libraries such that they transmit communication requests of the agent to the blocking module. The blocking module can block or approve these communication requests and thus advantageously suppress control commands in the direction of the first computer unit.

According to another aspect of the present invention, a method for computer-assisted processing of data for the analysis of an object of a system operator includes transmitting first data of a first data store from the object to a first evaluation unit by a first application within a first computer unit locally associated with the object, processing the first data by the first evaluation unit, transmitting a first result by the first evaluation unit to the first application for entry into the first data store for communication to the object, transmitting the first data of the first data store via the Internet to a second data store and/or receiving second data of the second data store by an agent associated with the first computer unit, transmitting the second data of the second data store to a second evaluation unit by a second application within a second computer unit connected to a first computer unit via the Internet, processing the second data by the second evaluation unit, transmitting a second result by the second evaluation unit to the second application for entry into the second data store, and blocking a data exchange between the first data store and the second data store in a direction from the second data store to the first data store by a blocking module associated with the first computer unit.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic illustration of a system according to the present invention, including a plurality of computer units for analysis of objects in a cloud-based computer unit; and

FIG. 2 shows schematically the function of agents and the blocking module.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments may be illustrated by graphic symbols, phantom lines, diagrammatic representations and fragmentary views. In certain instances, details which are not necessary for an understanding of the present invention or which render other details difficult to perceive may have been omitted.

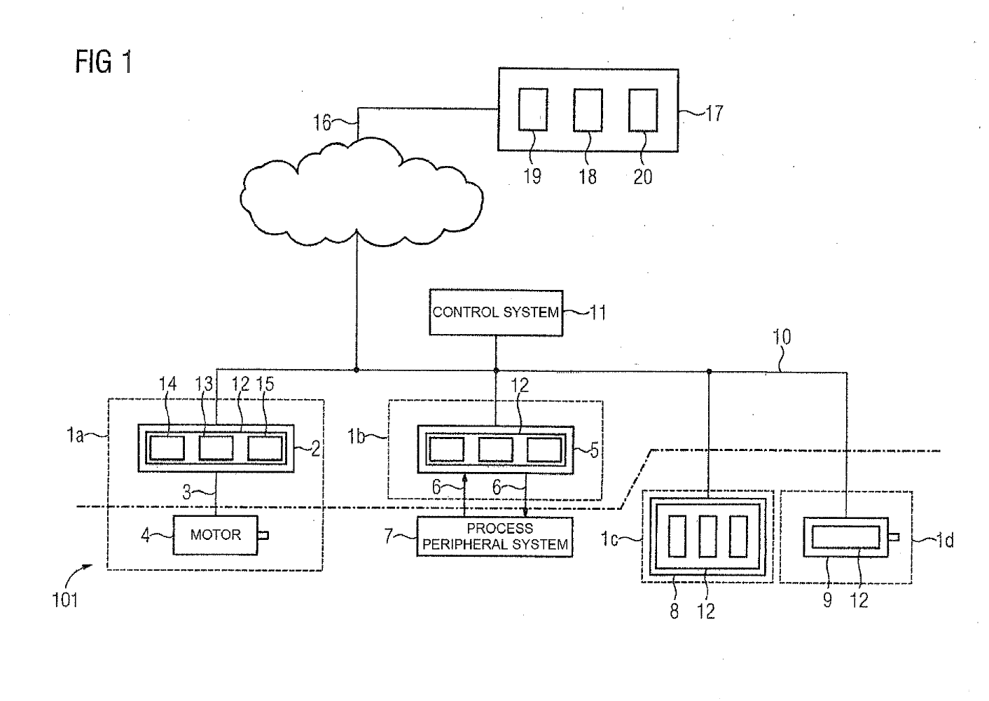

Turning now to the drawing, and in particular to FIG. 1, there is shown a schematic illustration of a system according to the present invention, generally designated by reference numeral 101, for the analysis of objects 1a to 1d. The objects are automation components in the control and field level, as are known, for example, in factory automation. The object 1a is a motor 4 driven by an inverter 2 via the control lines 3. The object 1b is a programmable control system 5 which is connected in a conventional manner via digital/analog inputs/outputs 6 to a process peripheral system 7. In a further variant, the object 1c is an intelligent field device 8 and the object 1d is an intelligent, directly controllable motor 9. The objects are connected via a local communication network 10 and in this example are connected to a control system 11 which carries out higher-order control and monitoring functions. The objects 1a to 1d supply object data 22 which is both internal object data (formed and calculated within the object) and external object data (status data from the process level 101). Computer units 12 which carry out the processing of the object data, monitor, control or regulate the objects are associated with the objects. For this purpose, the computer units 12 are provided with at least one evaluation unit 13, data stores 14 and applications 15. By means of the data connection 16, computer units 12 of the objects are connected to a computer unit 17 which is external to the plant and exchange data with it. The data connection 16 is preferably realized via the Internet. Objects as shown in FIG. 1 are from the same system operator, although different system operators can also be connected via the Internet to the computer unit 17 and transmit object data to it. The computer unit 17 includes an evaluation unit 18 and a data store 19. Applications 20 carry out the processing of the object data with the aid of the evaluating device 18 and data stores 19. The applications 20 can represent more complex control and regulation functions (for example, in simulations), or analyses, history investigations, condition monitoring, etc.

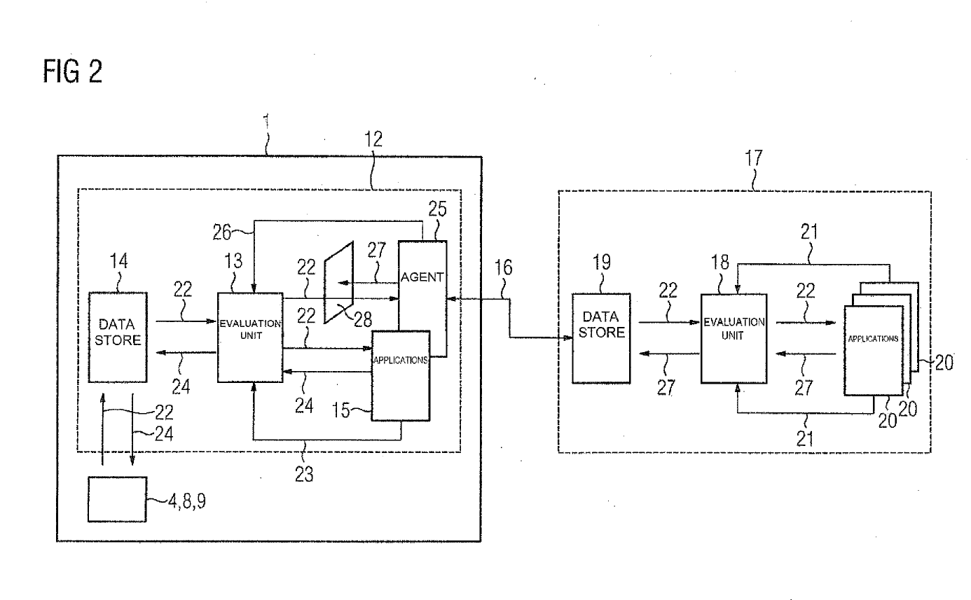

An agent 25—the function of which is shown in greater detail in FIG. 2—is used as a data gatherer and gathers and transfers the object data 22 to the computer unit 17.

FIG. 2 shows schematically the handling of the data in the first computer unit 12 and second computer unit 17. Herein, object data 22 pass from the object 1 as the data source to the data store 14. This data can be any internal object data, for example, currents or voltages of a connected motor or intermediate circuit voltages or currents of the inverter driving the motor, target value variables (thus also results 24) calculated internally for the objects. This data can however also be sensor data of external sensors or actuators relating to the object and/or the process controlled and/or monitored by the object. Depending on the embodiment, the object data can be transferred to the data store 14 continuously, periodically, time-controlled or event-controlled. The data store 14 interacts with the evaluation unit 13. The evaluation unit 13 has access to the data store 14 and can request or call object data 22 therefrom. The evaluation unit 13 can be realized as a combination of hardware and software. In the variant described here, the evaluation unit is configured as an independent third computer unit separate from the data stores 14. By means of the evaluation unit 13, requests from different uses or applications 15 are processed. The applications 15 herein represent a program executable on the computer unit 12. One application 15 causes the evaluation unit 13 to process object data 22 of the data store 14 according to the instruction 23 contained in the application 15 and to transfer the results 24 of this processing to the data store 14 for communication to the object 1. The object 1 can be controlled and influenced by means of these results. An agent 25 of a service operator which proceeds as per FIG. 2 as executable software within the computer unit 12 causes, by means of instructions 26, the evaluation unit 13 to take the object data 22 and results 24 of the data store 14 via the data connection 16 to the computer unit 17 external to the plant. The computer unit 17 includes data stores 19, an evaluation unit 18 and applications 20. The computer unit 17 can include applications from different service operators. The application 20 instructs the evaluation unit 18 to process object data 22 of the data store 19 according to the instruction 21 contained in the application 20 and to deposit the results 27 in the data store 19. By means of the agent 25 and the data connection 16, data of the data store 19 can pass to the computer unit 12. It is shown schematically in FIG. 2 how the agent 25 has access to data relating to the results 27. In order to prevent control functions being carried out undesirably by the agent on the objects (herein by way of example, on the basis of the results 27 of the application 20), a blocking module 28 is provided which suppresses write accesses to the data store 14. This is expressly also the case when the instruction 26 of the agent 25 instigates the evaluation device 13 to transfer results 27 to the data store 14 for communication to the object 1. The blocking module 28 runs here as a separate process on the same evaluation unit.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A system for the analysis of an object of a system operator, comprising:
a first computer unit which is locally associated with the object, said first computer unit comprising a first data store which includes data of the object, a first evaluation unit, and a first application which causes the first evaluation unit to process data of the first data store so as to produce a first result for transfer to the first data store for communication to the object,
a second computer unit which comprises a second data store, a second evaluation un)t, and a second application which causes the second evaluation unit to process data of the second data store so as to produce a second result for transfer to the second data store;
an agent associated with the first computer unit and providing data of the first data store via the Internet to the second data store and/or receiving data from the second data store; and
a blocking module associated with the first computer unit and configured to block a data exchange between the first data store and the second data store in a direction from the second data store to the first data store.

2. The system of claim 1, wherein the data exchange between the first data store and the second data store is blockable in a direction from the first data store to the second data store.

3. The system of claim 1, wherein the blocking module is accessible by a rule editor that is configurable by the system operator.

4. The system of claim 1, wherein the blocking module is implemented as a separate software module in an independent blocking program of the at least one first computer unit.

5. The system of claim 1, wherein the blocking module is callable by the agent using a communication request.

6. The system of claim 5, wherein the first computer unit comprises a third application for administering the first data store, said blocking module being callable from the third application after the making of the communication request by the agent.

7. The system of claim 1, wherein the blocking module is implemented as a software module in the agent.

8. The system of claim 1, wherein the blocking module is implemented on dedicated hardware.

9. The system of claim 1, wherein the blocking module blocks all requests for network, file or memory operations of the operating system.

10. The system of claim 5, wherein the blocking module comprises a mediator module which injects mediator functions into runtime libraries of communication protocols, which notify the blocking module regarding the communication request.

11. A method for computer-assisted processing of data for the analysis of an object of a system operator, comprising:
transmitting first data of a first data store from the object to a first evaluation unit by a first application within a first computer unit locally associated with the object;
processing the first data by the first evaluation unit;
transmitting a first result by the first evaluation unit to the first application for entry into the first data store for communication to the object;
transmitting the first data of the first data store via the Internet to a second data store and/or receiving second data of the second data store by an agent associated with the first computer unit;
transmitting the second data of the second data store to a second evaluation unit by a second application within a second computer unit connected to a first computer unit via the Internet;
processing the second data by the second evaluation unit,
transmitting a second result by the second evaluation unit to the second application for entry into the second data store; and
blocking a data exchange between the first data store and the second data store in a direction from the second data store to the first data store by a blocking module associated with the first computer unit.

12. The method according to claim 11, further comprising blocking the data exchange between the first data store and the second data store in a direction from the first data store to the second data store.

13. The method of claim 11, further comprising formulating a communication request by the agent, transmitting the communication request to the blocking module, evaluating the communication request by the blocking module on the basis of a logic installed in the blocking module, forming a decision on whether to grant the communication request in the blocking module, transmitting the decision to the agent, and rejecting and executing the communication request by the agent depending on the decision of the blocking module.

14. The method of claim 11, further comprising formulating a communication request by the agent, transmitting the communication request to a third administration application for the first data store, transmitting the communication request from the third administration application to the blocking module, evaluating the communication request by the blocking module on the basis of a logic installed in the blocking module, forming a decision on whether to grant the communication request in the blocking module, transmitting the decision to the third administration application, and blocking and approving the communication request of the agent by the third administration application.
